(19) United States
(12) Patent Application Publication
(10) Pub. No.: US 2023/0237746 A1
(43) Pub. Date: Jul. 27, 2023

(54) System and Methods for Enhancing Videoconferences

(71) Applicant: Zenapptic AI Inc., Montreal (CA)

(72) Inventor: David WILKINS, Montreal (CA)

(21) Appl. No.: 18/159,617

(22) Filed: Jan. 25, 2023

Related U.S. Application Data
(60) Provisional application No. 63/476,054, filed on Dec. 19, 2022.
(60) Provisional application No. 63/303,332, filed on Jan. 26, 2022.

(51) Int. Cl. G06T 19/00; G06F 3/0484

(52) U.S. Cl. CPC G06T 19/006; G06F 3/0484; G06T 2219/024; H04L 65/403

(57) ABSTRACT

Enhancing videoconferences by providing a multimedia client module as an interface between a videoconferencing client and a backend server providing various inputs. The multimedia client module may be installed directly on a user's personal computing device, on a specialized computing device accessible by the user's computing device, or on a cloud server. The multimedia client module may be configured to overlay and/or integrate various data into a video teleconferencing (VTC) camera feed.

### CROSS REFERENCE TO RELATED APPLICATIONS AND CLAIM OF PRIORITY

The present application claims priority to U.S. provisional patent application No. 63/303,332, filed on Jan. 26, 2022, and to U.S. provisional patent application No. 63/476,054, filed on Dec. 19, 2022. The entire contents of these applications are incorporated herein by reference.

### TECHNICAL FIELD

The following relates to systems and methods for enhancing videoconferences, particularly videoconferences wherein multimedia content is shared.

### BACKGROUND

The use of live videoconferencing applications such as, for example, Zoom® and Microsoft Teams® for carrying out online meetings and presentations has become more important than ever given the rise in remote work and online meetings and events.

In a professional context, online meetings and presentations often rely on software programs such as Microsoft PowerPoint® to convey information. However, it is often the case that such multimedia content must be viewed using screen sharing or circulated to participants before the meeting. Additionally, presenters may each require their own presentation which can lead to difficulties maintaining a consistent look and feel between presentations, and switching between presentations and other information that is to be displayed can be cumbersome and may lead to inefficient use of meeting time.

It is recognized that it is desirable to develop improved methods and systems for generating multimedia content over videoconferencing applications.

### SUMMARY

It has been found that by providing a multimedia client module as an interface between a videoconferencing client and a server providing various inputs used to enhance the videoconference, the challenges associated with rendering a consistent, broadcast-quality meeting may be reduced, minimized, or eliminated. The multimedia client module may be installed directly on the user's personal computing device, on a specialized computing device accessible by the user's computing device, or on a cloud server. The multimedia client module may be configured to overlay and/or integrate various data into a video teleconferencing (VTC) camera feed.

In one aspect, provided is a method for enhancing a videoconference presentation comprising: by a multimedia module: receiving presentation data and one or more additional data inputs from one or more servers; and by a real-time rendering engine and virtual camera driver, overlaying the presentation output in a video teleconferencing camera feed.

In an implementation, the method comprises providing a user input mechanism to control the one or more additional data inputs.

In another implementation, the one or more additional data inputs comprise presentation templates, real-time data and/or static graphics.

In another aspect, provided is a method for enhancing a videoconference presentation comprising: by a multimedia module: receiving presentation data and one or more additional data inputs from one or more servers; and by a real-time rendering engine and virtual camera driver, overlaying the presentation output in a video teleconferencing camera feed; by an AI module, provide visual prompts to attendees of the meeting, via an attendee computing device, to notify the attendees of one or more of elapsed time, agenda items, and progress of a presenting attendee in relation to a meeting agenda.

In an implementation, the method further comprises providing a user input mechanism to control the one or more additional data inputs.

In another implementation, the one or more additional data inputs comprise presentation templates, real-time data and/or static graphics.

In yet another aspect, provided is a system to carry out the methods.

In yet another aspect, provided is a system for facilitating a video conference coupling multiple meeting participants via a network, the system comprising: a communication network configured to provide data transmission from a source to one or more destinations; a plurality of user computers, coupled to the communication network, configured to be utilized by meeting attendees for a video conference; and a server coupled to the plurality of client computers via the communication network and configured to manage the video conference between the attendees, the server configured to include: a real-time interactive graphics generator operable to generate graphics for visual content for each attendee; an AI module configured to track overall meeting time and, based on an agenda, to allot to each of the attendees a pre-defined amount of time, and to provide visual prompts by the graphics generator to the attendees to notify a presenting attendee of their status in relation to the pre-defined amount of time and/or to notify at one of the attendees of the time until the beginning of their pre-defined amount of time.

In an implementation, the system is further configured to prompt the presenting attendee to summarize their presentation and/or automatically create a form to send to the attendees or an assigned meeting notetaker.

In yet another aspect, provided is a method for enhancing a videoconference presentation comprising: by a multimedia module: receiving presentation data and one or more additional data inputs from one or more servers; and by a real-time rendering engine and virtual camera driver, overlaying the presentation output in a video teleconferencing camera feed; by an AI module, provide visual prompts to attendees of the meeting, via an attendee computing device, to notify the attendees of one or more of elapsed time, agenda items, and progress of a presenting attendee in relation to a meeting agenda.

In an implementation, the method further comprises comprising providing a user input mechanism to control the one or more additional data inputs.

In another implementation, the one or more additional data inputs comprise one or more of presentation templates, real-time data, static graphics, virtual whiteboards and video streams.

In yet another implementation wherein the presentation templates comprise 2D or 3D environments simulating a 3D space, containing the presentation data and one or more data inputs such as live camera feeds, slide decks, real time data, static graphics, online documents, photos, videos and collaborative virtual whiteboards. The visual information are placed within the environments at pre-determined locations and/or overlaid (placed between the viewpoint and the environment).

In yet another aspect, provided is a system configured to carry out the above methods.

In yet another aspect, provided is a system for facilitating a video conference coupling multiple meeting participants via a network, the system comprising: a communication network configured to provide data transmission from a source to one or more destinations; a plurality of user computers, coupled to the communication network, configured to be utilized by meeting attendees for a video conference; and a server coupled to the plurality of client computers via the communication network and configured to manage the video conference between the attendees, the server configured to include: a real-time interactive graphics generator operable to generate graphics for visual content for each attendee; an AI module configured to track overall meeting time and, based on an agenda, to allot to each of the attendees a pre-defined amount of time, and to provide visual prompts by the graphics generator to the attendees to notify a presenting attendee of their status in relation to the pre-defined amount of time and/or to notify at one of the attendees of the time until the beginning of their pre-defined amount of time.

In an implementation, the system is configured to prompt the presenting attendee to summarize their presentation and/or automatically create a form to send to the attendees or an assigned meeting notetaker.

In yet another aspect, provided is a method for enhancing a videoconference presentation comprising: by a multimedia module: receiving presentation data and one or more additional data inputs from one or more servers; and by a real-time rendering engine and virtual camera driver, overlaying the presentation output in a video teleconferencing camera feed; by an AI module, provide visual prompts to attendees of the meeting, via an attendee computing device, to notify the attendees of one or more of elapsed time, agenda items, and progress of a presenting attendee in relation to a meeting agenda.

In an implementation, the method further comprises providing a user input mechanism to control the one or more additional data inputs.

In another implementation, the one or more additional data inputs comprise one or more of presentation templates, real-time data, static graphics, virtual whiteboards and video streams.

In yet another implementation, the presentation templates comprise 2D or 3D environments simulating a 3D space, containing the presentation data and one or more data inputs such as live camera feeds, slide decks, real time data, static graphics, online documents, photos, videos and collaborative virtual whiteboards.

In yet another implementation, the visual information are placed within the environments at pre-determined locations and/or placed between a viewpoint and the environment.

In yet another aspect, provided is a system for facilitating a video conference coupling multiple meeting participants via a network, the system comprising: a communication network configured to provide data transmission from a source to one or more destinations; a plurality of user computers, coupled to the communication network, configured to be utilized by meeting attendees for a video conference; and a server coupled to the plurality of client computers via the communication network and configured to manage the video conference between the attendees, the server configured to include: a real-time interactive graphics generator operable to generate graphics for visual content for each attendee; an AI module configured to track overall meeting time and, based on an agenda, to allot to each of the attendees a pre-defined amount of time, and to provide visual prompts by the graphics generator to the attendees to notify a presenting attendee of their status in relation to the pre-defined amount of time and/or to notify at one of the attendees of the time until the beginning of their pre-defined amount of time.

In an implementation, the system is further configured to prompt the presenting attendee to summarize their presentation and/or automatically create a form to send to the attendees or an assigned meeting notetaker.

In another implementation, the system is further configured to provide a user input mechanism to control the one or more additional data inputs.

In yet another implementation, the one or more additional data inputs comprise one or more of presentation templates, real-time data, static graphics, virtual whiteboards and video streams.

In yet another implementation, the presentation templates comprise 2D or 3D environments simulating a 3D space, containing the presentation data and one or more data inputs such as live camera feeds, slide decks, real time data, static graphics, online documents, photos, videos and collaborative virtual whiteboards

In yet another implementation, the visual information are placed within the environments at pre-determined locations and/or placed between the viewpoint and the environment.

### BRIEF DESCRIPTION OF THE DRAWINGS

Embodiments will now be described by way of example only with reference to the appended drawings wherein:

FIG. 1 is a schematic diagram of a videoconference enhancement system.

FIG. 2 is a pictorial diagram of an embodiment of the videoconference enhancement system shown in FIG. 1.

FIG. 3 is a pictorial diagram of another embodiment of the videoconference enhancement system shown in FIG. 1.

FIG. 4 is a pictorial diagram of yet another embodiment of the videoconference enhancement system shown in FIG. 1.

FIG. 5 illustrates several screenshots of examples of pre-built template widgets for title and static graphics.

FIG. 6 illustrates several screenshots of examples of pre-built template widgets for data driven graphics.

FIG. 7 illustrates a screenshot of an example of a pre-built template widget displaying real-time interactive graphics.

FIG. 8 illustrates a screenshot of an example of a mobile application shown in “builder mode” whereby a user may browse a library of ready-to-use graphics widgets. In some embodiments, the library may contain hundreds of widgets in various themes and styles. The user may select a widget, customize its content and behavior, and add it to the rundown.

FIG. 9 illustrates a screenshot of an example of a mobile application shown in “rundown playout mode” whereby new rundowns may be created, or existing ones may be created. In some embodiments, a user may press and drag to change the order of widgets in the rundown, may press the “Next” to button to display the next widget in the rundown, and press the “Previous” button to display the previous widget in the rundown.

FIG. 10 illustrates a screenshot of an example of a mobile application shown in “control mode”. In some embodiments, a control panel is provided with customizable buttons for controlling discrete events, such as resetting the output, starting and stopping the video camera, and showing predefined content independent of the rundown.

FIG. 11 illustrates a screenshot of an example embodiment of a 3D meeting environment having real-time and/or static graphics overlaid thereon.

FIG. 12 illustrates a screenshot of another example embodiment of a 3D meeting environment having real-time and/or static graphics overlaid thereon.

FIG. 13 illustrates a screenshot of yet another example embodiment of a 3D meeting environment having real-time and/or static graphics overlaid thereon.

FIG. 14 illustrates a screenshot of an example embodiment of a 2D meeting environment having real-time and/or static graphics overlaid thereon.

FIG. 15 illustrates a screenshot of yet another example embodiment of a 3D meeting environment having real-time and/or static graphics overlaid thereon.

FIG. 16 illustrates a screenshot of yet another example embodiment of a 3D meeting environment having real-time and/or static graphics overlaid thereon.

FIG. 17 illustrates a screenshot of yet another example embodiment of a 3D meeting environment having real-time and/or static graphics overlaid thereon.

FIG. 18 illustrates a screenshot of yet another example embodiment of a 3D meeting environment having real-time and/or static graphics overlaid thereon, and including two presenters.

### DETAILED DESCRIPTION OF THE DRAWINGS

Provided herein is a multimedia client module that may serve as an interface between a videoconferencing client and one or more servers providing various inputs used to enhance the videoconference. The multimedia client module may enhance videoconferencing meetings by providing consistent templates for presentations and by overlaying static and data driven graphics to facilitate information sharing and to provide a professional, or broadcast-quality aesthetic.

The multimedia client module may be installed directly on a user's personal computing device, on a specialized computing device accessible by the user's computing device, or on a cloud server. The multimedia client module may be configured to overlay and/or integrate various data into a video teleconferencing (VTC) camera feed. Suitable VTC systems may include, but are not limited to, Zoom®, Microsoft Teams®, Webex®, GoToMeeting®, Amazon Chime®, Google Meet® and Google Slides®.

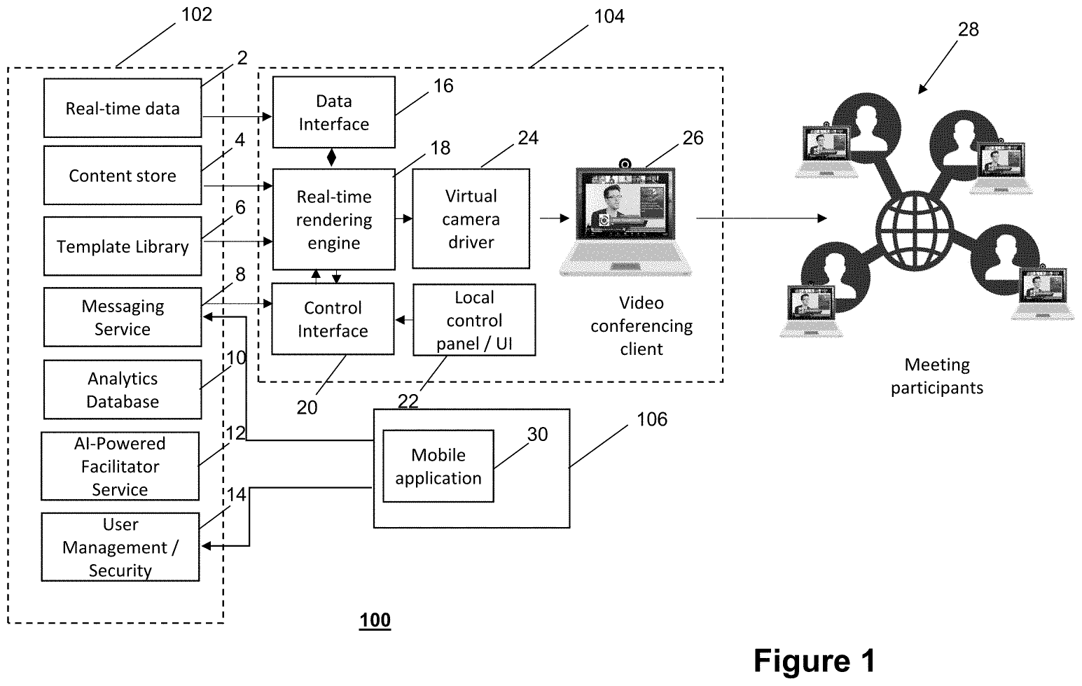

FIG. 1 illustrates a videoconferencing system 100 which may be configured in numerous ways, one of which is exemplified in FIG. 1. The system 100 in this example comprises a multimedia client module 104 which may generate a broadcast-quality videoconference as discussed above. Generally, the multimedia client module 104 may obtain a presentation from a backend server 102 (local or cloud) and convert, by a suitable real-time rendering engine 18 and virtual camera driver 24, the presentation to an output overlaid onto a VTC feed generated by a video conferencing client 26 (e.g., those outlined above). In some example embodiments, the multimedia client 104 may be installed in the cloud, and in such embodiments, the virtual camera driver 24 may not be required. The multimedia client module 104 may further comprise or have access to a data interface 16, a control interface 20, and a local control panel/user interface 22. As described in greater detail below, a mobile application 30 may optionally be provided to assist with presentation generation, organization, and operation. The mobile application 30 may be installed on or accessed by a mobile computing device 106 (e.g., a smartphone or tablet). The server 102 may include or otherwise have access to real-time data 2, a content database 4, a template database 6, a messaging service 8, an analytics database 10, an AI-powered videoconference facilitator service 12 and/or a user management/security module 14.

The content store 4 may comprise a repository of meeting related content in various formats. The meeting related content may include, for example, presentation files, documents, reports, meeting minutes, meeting agendas, images and videos. Generally, the meeting content may be any content beneficial to a meeting attendee. Such content may be accessed during or outside of a meeting.

The real-time rendering engine 18 may, in combination with one or more of, e.g., the real-time data module 2, the content store 4 and the template library 6, generate meeting-specific, data-driven templates with real-time data automatically linked to the templated graphics. For example, a “Closed Sales by Sales Rep” graphic with real-time data may be automatically populated from Salesforce® Customer Relationship Management (“CRM”) platform). As data changes, the graphics may automatically update. This may be particularly useful for meetings where reporting of data is a significant part of the meeting (e.g., weekly sales update meetings). This feature may advantageously reduce or obviate the need to spend time prior to the meeting creating reports or slides, as the graphics can be automatically generated during the meeting itself. Real-time data sources may include, but are not limited to, internal 3rd party systems (e.g., sales CRM, supply chain data) and external sources such as stock market indices, stock prices, social media messages, and news feeds. The template library 6 may include template packages for, e.g., sales update, board of directors, operations, company, strategy, brainstorming, and team-building meetings. The template library 6 may also include template packages for generating 3D meeting environments, 3D “town hall” or conference environments with participants, 3D event space environments, and the like.

The control interface 20 may work in concert with the control panel 22 to carry out actions selected by the presenter. For example, via the control panel 22, the presenter may access and display graphics, switch to different presentation modes, and control the flow of the meeting.

The AI facilitator 12 module or component may comprise AI features for managing the flow of a meeting. For example, the AI facilitator 12 may act as a timekeeper for following a meeting agenda, prompting users to start their part of a presentation, and may provide analytics reports with suggestions for improving meeting efficiency. During a meeting, the AI facilitator 12 may be configured to prompt the meeting host to assign roles (can be visual or voice-activated) and assign participants to agenda items, and to track the meeting participants as the agenda items are covered. The AI meeting facilitator may track the overall meeting time, and may be programmed to allot to each participant a pre-defined amount of time, and provide visual prompts to participants to, for example, enable them to see how much time they have left in their part of the meeting or if their turn is near. The AI meeting facilitator may at the end of each allotted period of time prompt the participant to summarize their presentation and/or may automatically create a form to send to participants or an assigned meeting notetaker.

The AI meeting facilitator may be configured to automatically match agenda items to a particular presentation or page of a presentation slide deck, and navigate to the appropriate file or slide at the appropriate time. In some embodiments, the AI meeting facilitator 12 may include or be in communication with the analytics database 10. The analytics database 10 may be configured to store and analyze data provided by the AI meeting facilitator 12. The analytics database 10 may be programmed to determine patterns in the meeting data. For example, the analytics database 10 may determine that certain topics and/or participants tend to use more than their pre-determined allotted time. Based on such insights, the AI meeting facilitator 12 may provide prompts/suggestions to authorized participants to adjust the meeting agenda and/or adjust the prompts accordingly.

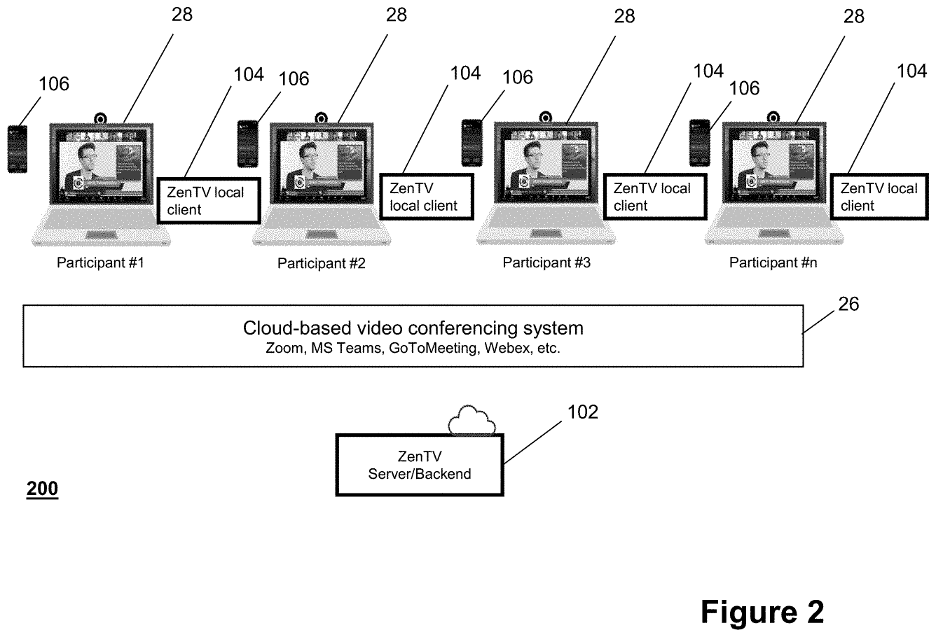

For ease of illustration, FIGS. 2-4 discussed below above do not illustrate connections between the components shown therein; however, such connections will be apparent to those skilled in the art.

FIG. 2 illustrates an example embodiment of a videoconferencing system 200 comprising the multimedia client module 104, wherein each participant 28 has their own copy of the multimedia client module 104 installed on their computing device. Optionally, one or more of the participants 28 may have the mobile application 28 installed on their mobile devices 106. In this example embodiment, the multimedia client module 104 may connect to the backend server 102 via the cloud.

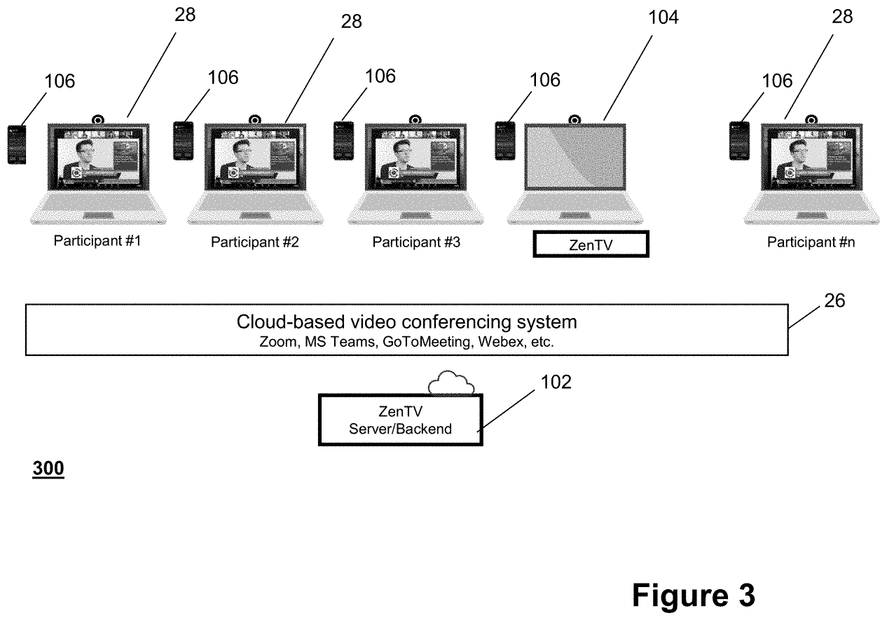

FIG. 3 illustrates another example embodiment of a videoconferencing system 300, wherein the multimedia client module 104 is accessible over the cloud and thus does not need to be installed on the participants' 28 computing devices. The participants 28 may use the mobile application 30 installed on their devices 106 to control the multimedia client module 104. The multimedia client module 104 and application 30 may be configured with various user permissions. For example, in one configuration, only the participant hosting the meeting may initially be able to generate, organize and operate presentations, but may provide other participants with permissions to access, organize and operate only their own presentations. In the example shown, the multimedia client module 104 appears as a participant in the meeting.

In other embodiments, the multimedia client module 104 may be browser-based, such that the presenter may share a web browser window running the module 104. Each participant may be a presenter and share their presentation. The presenter may control the module 104 via mobile apps on their mobile devices.

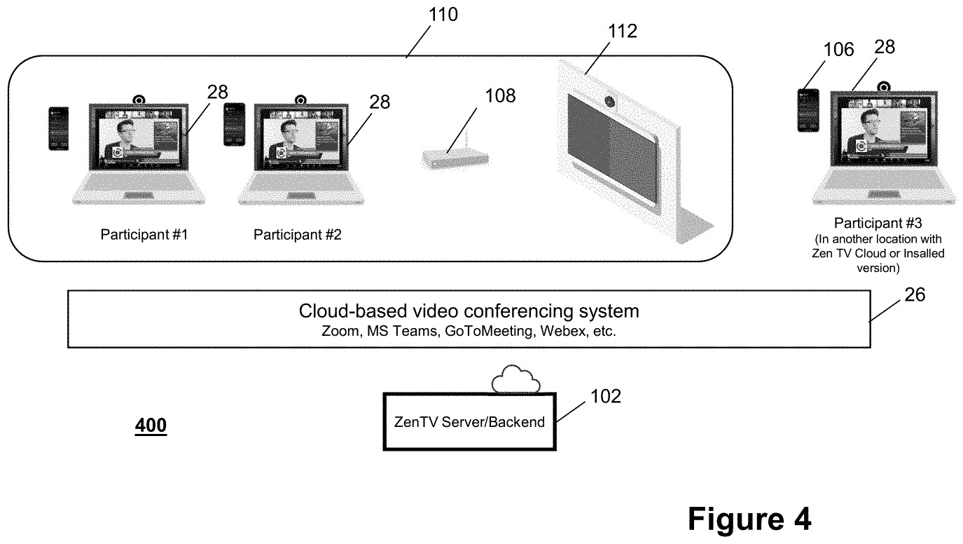

FIG. 4 illustrates yet another example embodiment of a videoconferencing system 400 comprising a specialized hardware appliance 108 having installed thereon the multimedia client module 104 (not shown) which may be in communication with the backend server 102 across a network. The hardware appliance 108 may be in communication, wirelessly or physically, with a monitor and camera (112, collectively) provided in a meeting room with one or more of the participants 28 participating in a videoconference. One or more other participants 28 may access the same videoconference remotely using installed or cloud versions of the multimedia client module 104 as discussed above.

In further example embodiments, videoconferencing systems may be provided including any combination of the installed client, cloud client or hardware client configurations.

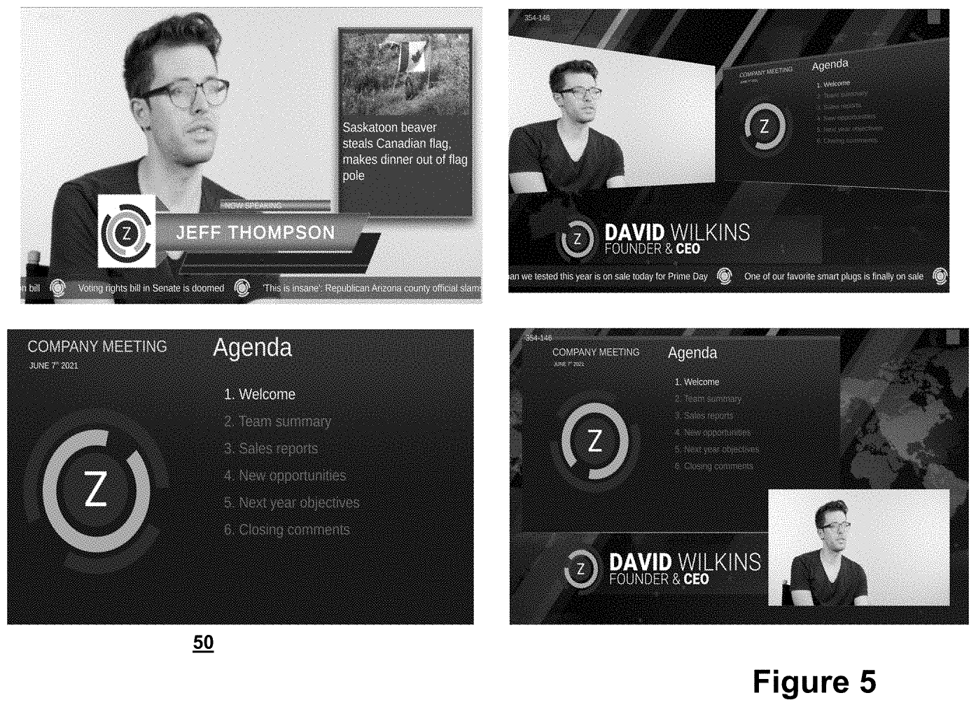

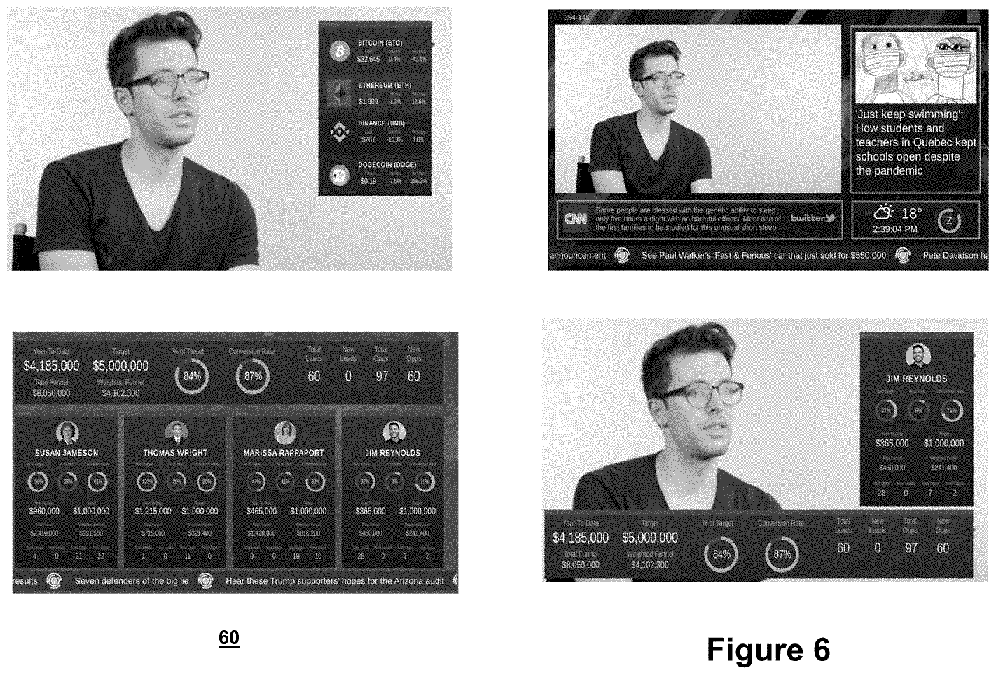

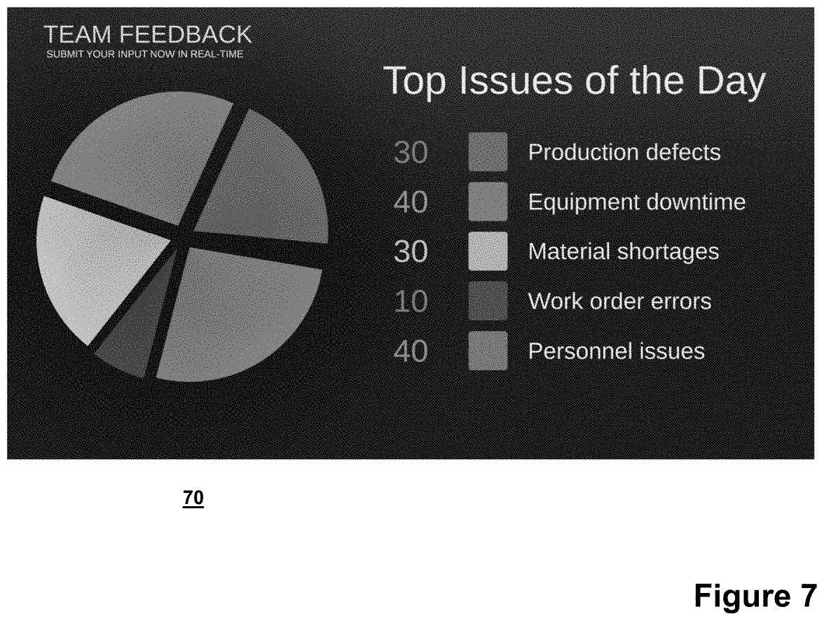

FIG. 5 illustrates several example embodiments of screenshots 50 of pre-built template widgets for title, branding and static graphics (e.g., a meeting agenda). FIG. 6 illustrates several screenshots 60 of examples of pre-built template widgets for data driven graphics. FIG. 7 illustrates a screenshot 70 of an example of a pre-built template widget displaying real-time interactive graphics.

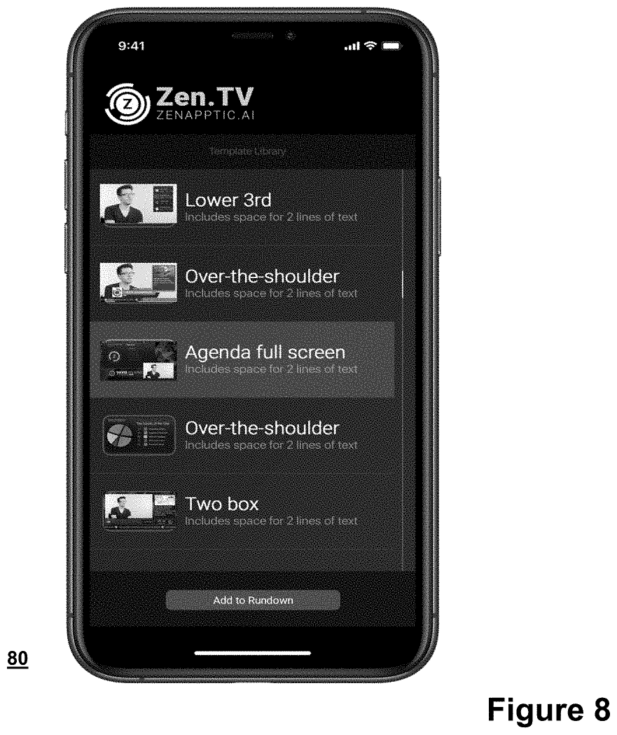

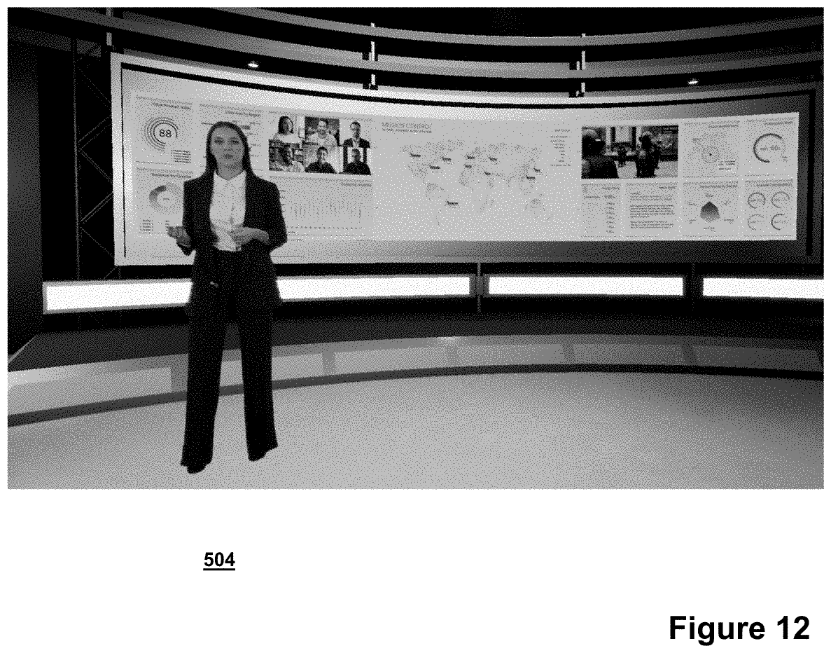

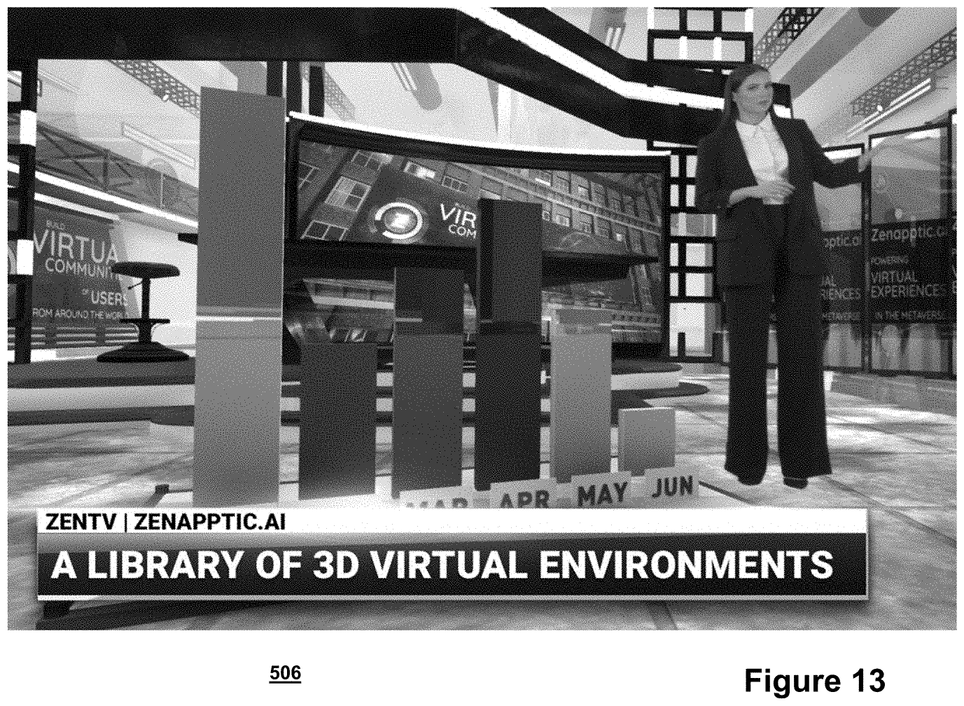

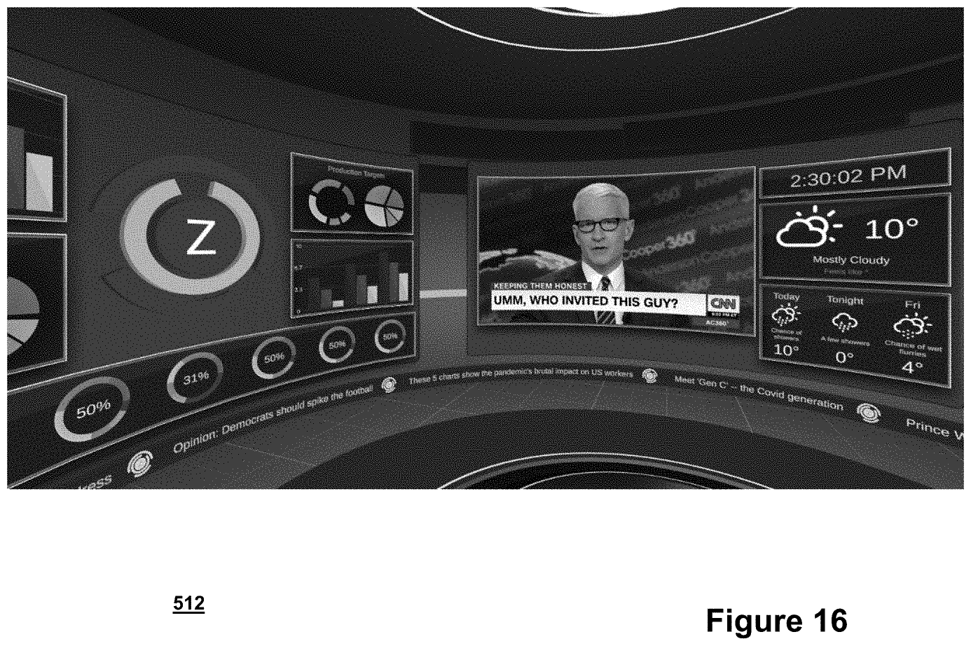

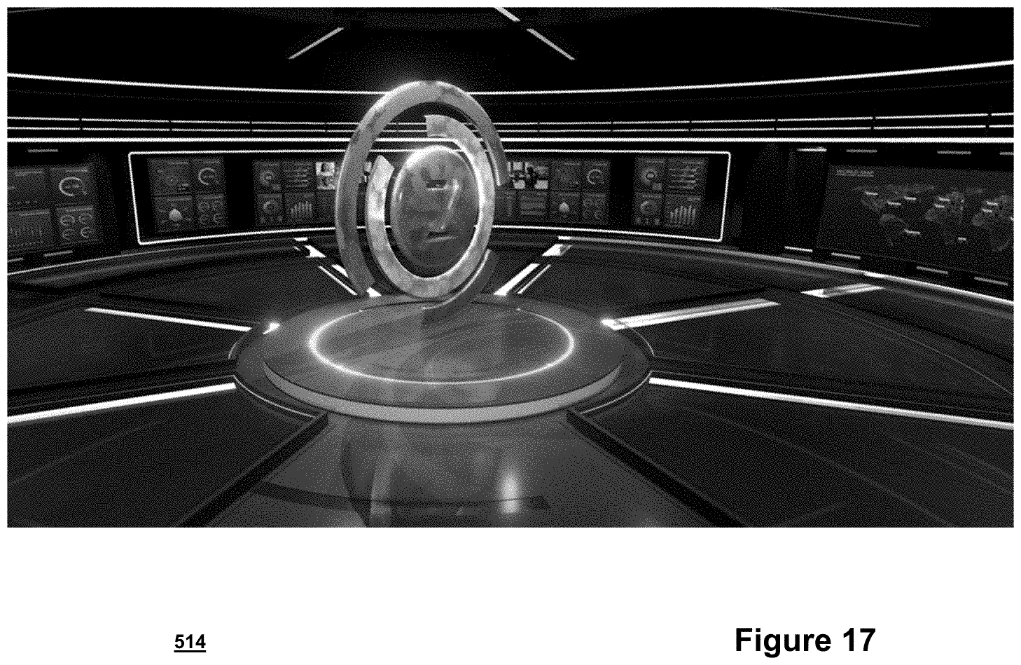

FIG. 8 illustrates a screenshot 80 of an example of a mobile application shown in “builder mode” whereby a user may browse a library of ready-to-use graphics widgets (e.g., those shown in FIG. 5-7 or 11-17. In some embodiments, the library contains hundreds of widgets in various themes and styles. The user may select a widget, customize its content and behavior, and add it to the rundown (i.e., to the customized presentation).

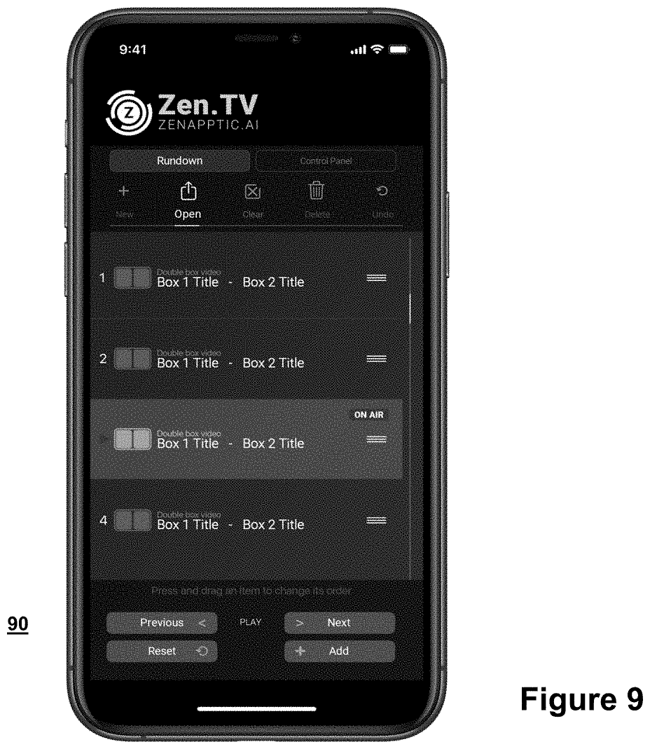

FIG. 9 illustrates a screenshot 90 of an example of a mobile application shown in “rundown playout mode” whereby new rundowns may be created, or existing ones may be modified. In some embodiments, a user may press and drag to change the order of widgets in the rundown, may press the “Next” to button to display the next widget in the rundown, and press the “Previous” button to display the previous widget in the rundown.

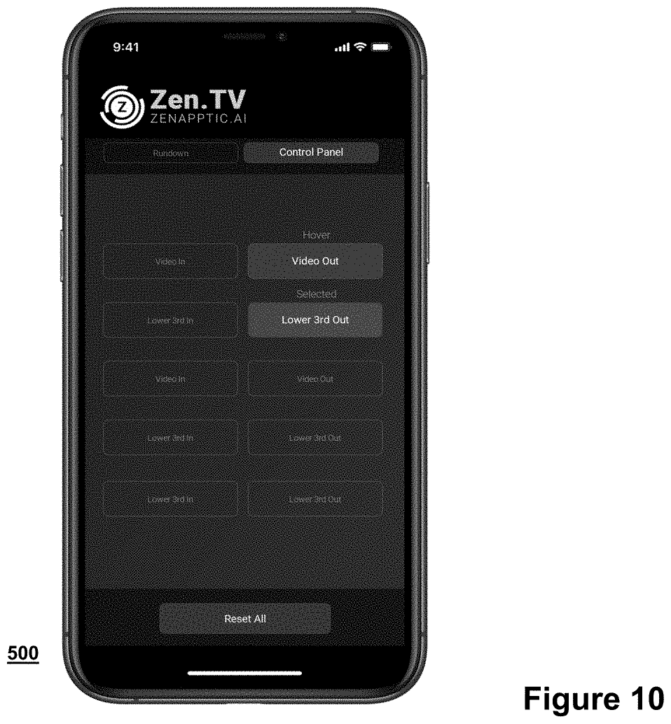

FIG. 10 illustrates a screenshot 500 of an example of a mobile application shown in “control mode”. In some embodiments, a control panel is provided with customizable buttons for controlling discrete events, such as resetting the output, starting and stopping the video camera, and showing predefined content independent of the rundown.

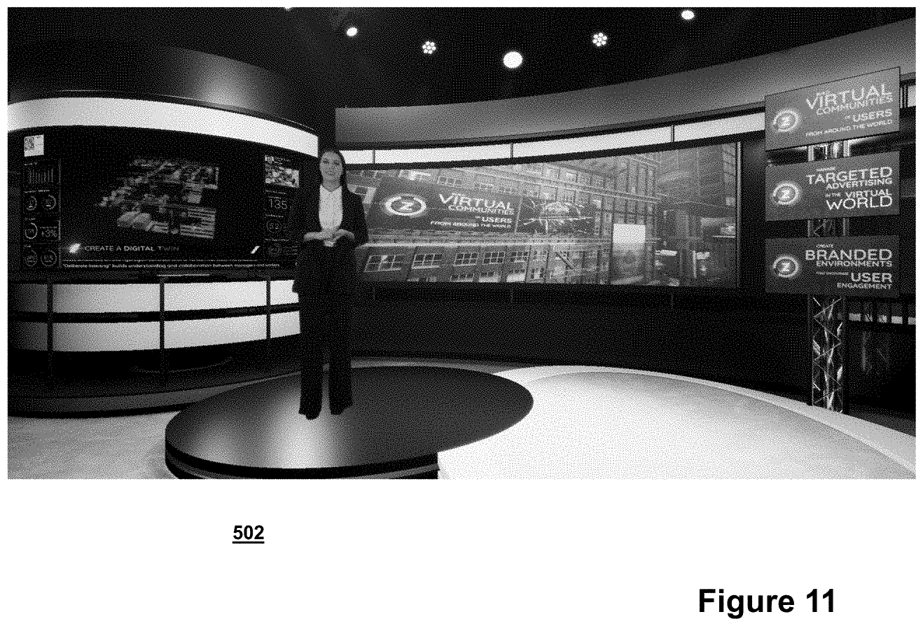

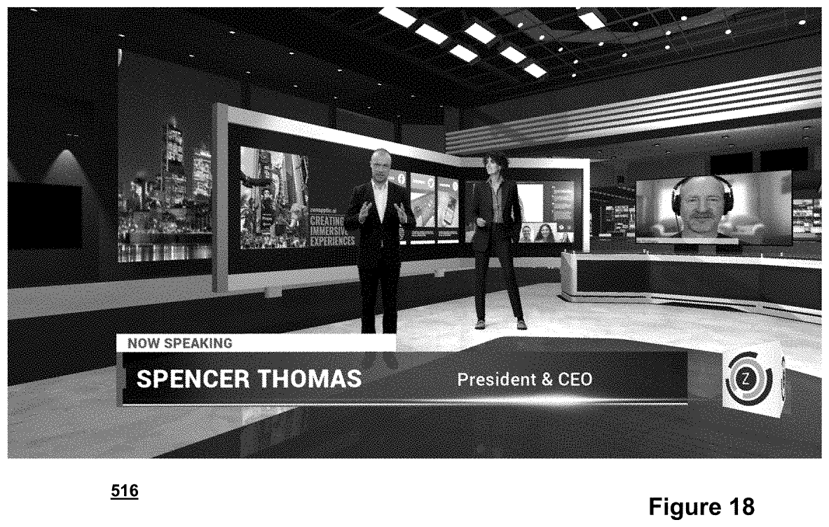

FIGS. 11-13 illustrate screenshots (502,504,506) of different 3D meeting room environments. In each example environment, the presenter appears in a newsroom- or presentation room-type environment. Additional presenters can be added to the 2D or 3D environment, as well as camera feed(s) from selected meeting attendees or guests. FIG. 18 illustrates a screenshot 516 of another 3D meeting room environment with more than one presenter and including a camera feed from a selected attendee/guest. The environments may optionally contain overlaid graphics, animations and other features. Such environments may be, for example, selected from the template library 106 using a mobile app (as shown in any one of FIGS. 8-10). The overlaid graphics, animations, and the like may be, for example, any of those described herein. The overlaid graphics may be 2D and/or 3D graphics. As described further above, the graphics may have links to real-time data (i.e., data-driven graphics), with the content updating automatically every time the graphics are shown, in real-time, and/or at pre-determined time intervals. The graphics may be packaged to ideally fit in different 3D environments.

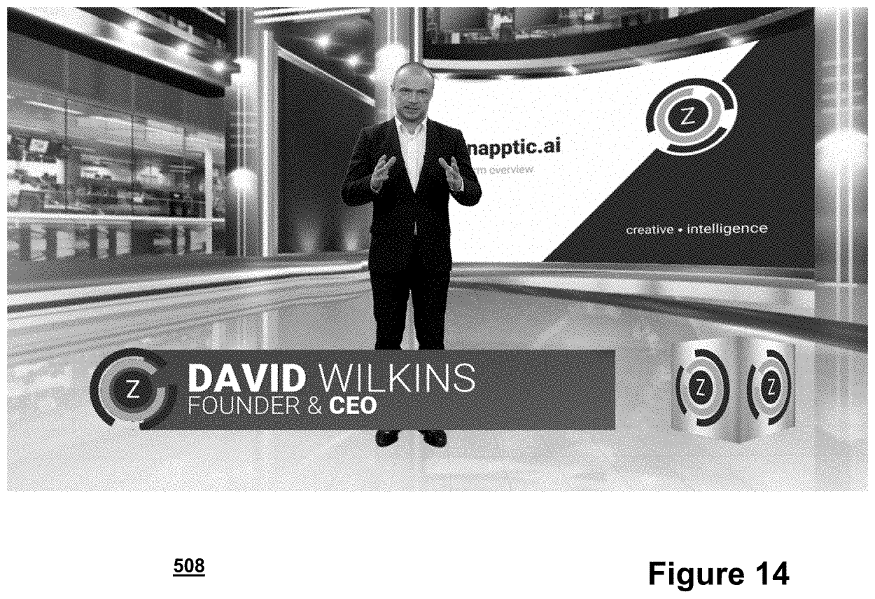

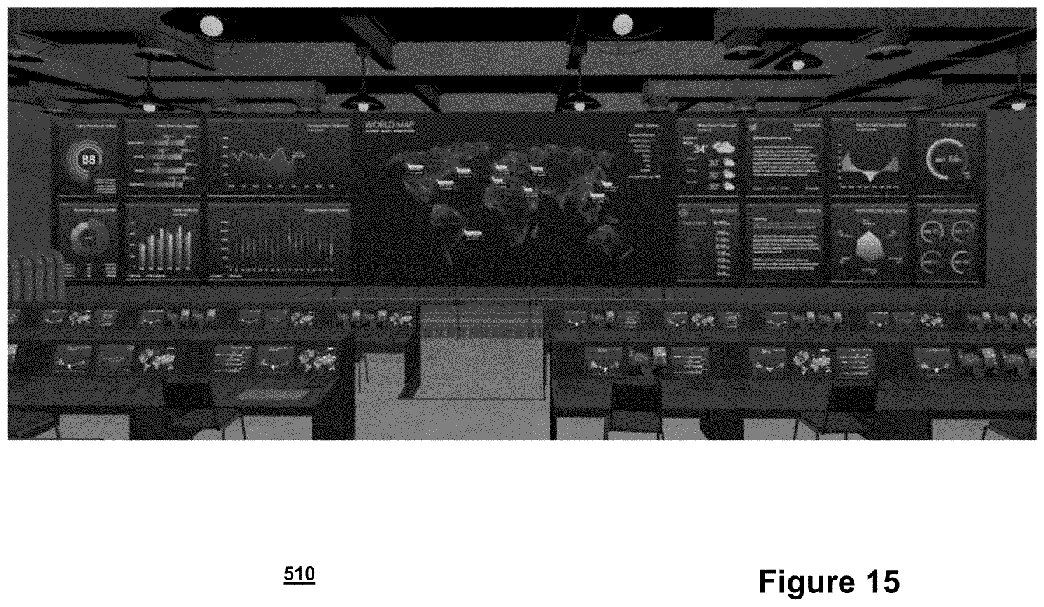

FIG. 14 illustrates screenshot 508 of an example embodiment of a virtual environment that appears to be 3D but is actually 2D. The environment may contain overlaid 2D and/or 3D graphics. FIGS. 15-17 show screenshots (510,512,514) of further example embodiments of such virtual environments.

The virtual environments (e.g., as shown in FIGS. 11-17) may include other content can be added over the background image (e.g., a PowerPoint slide deck, video stream, etc.). A shared or unshared whiteboard may also be included in any of the environments described herein to facilitate real-time collaboration and presentation. The whiteboard may enable sketching in 2D or 3D. The environments and graphics/features shown therein according to the present disclosure may be integrated with Teams/Zoom collaboration features, Office 365, Google Doc sharing, real-time polls, survey questions, and other features. In some embodiments, the control panel or buttons may be on a mobile app, or on a web browser accessible by a mobile phone. In other embodiments, the control panel or buttons may be accessible on a separate browser window on the presenter's computing device (e.g., desktop computer or laptop). That is, the functionality described herein with respect to the mobile application may be available on a web browser accessible by a presenter's computing device. In some embodiments, one or more buttons or controls may be incorporated into the presentation environment itself, such that a presenter may click on graphics/images representing a button, resulting in a change without the presenter needing to leave the presentation environment (i.e., either via a mobile phone or different browser window).

The methods described herein may be embodied in sets of executable machine code stored in a variety of formats such as object code or source code. The executable machine code or portions of the code may be integrated with the code of other programs, implemented as subroutines, plug-ins, add-ons, software agents, by external program calls, in firmware or by other techniques as known in the art.

Any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method for enhancing a videoconference presentation comprising:
by a multimedia module:
receiving presentation data and one or more additional data inputs from one or more servers; and
by a real-time rendering engine and virtual camera driver, overlaying the presentation output in a video teleconferencing camera feed;
by an AI module, provide visual prompts to attendees of the meeting, via an attendee computing device, to notify the attendees of one or more of elapsed time, agenda items, and progress of a presenting attendee in relation to a meeting agenda.

2. The method of claim 1, further comprising providing a user input mechanism to control the one or more additional data inputs.

3. The method of claim 1, wherein the one or more additional data inputs comprise one or more of presentation templates, real-time data, static graphics, virtual whiteboards and video streams.

4. The method of claim 1, wherein the presentation templates comprise 2D or 3D environments simulating a 3D space, containing the presentation data and one or more data inputs such as live camera feeds, slide decks, real time data, static graphics, online documents, photos, videos and collaborative virtual whiteboards.

5. The method of claim 4, wherein the visual information are placed within the environments at pre-determined locations and/or placed between a viewpoint and the environment.

6. A system for facilitating a video conference coupling multiple meeting participants via a network, the system comprising:
a communication network configured to provide data transmission from a source to one or more destinations;
a plurality of user computers, coupled to the communication network, configured to be utilized by meeting attendees for a video conference; and
a server coupled to the plurality of client computers via the communication network and configured to manage the video conference between the attendees, the server configured to include:
a real-time interactive graphics generator operable to generate graphics for visual content for each attendee;
an AI module configured to track overall meeting time and, based on an agenda, to allot to each of the attendees a pre-defined amount of time, and to provide visual prompts by the graphics generator to the attendees to notify a presenting attendee of their status in relation to the pre-defined amount of time and/or to notify at one of the attendees of the time until the beginning of their pre-defined amount of time.

7. The system of claim 6, further configured to prompt the presenting attendee to summarize their presentation and/or automatically create a form to send to the attendees or an assigned meeting notetaker.

8. The system of claim 6, further comprising providing a user input mechanism to control the one or more additional data inputs.

9. The system of claim 6, wherein the one or more additional data inputs comprise one or more of presentation templates, real-time data, static graphics, virtual whiteboards and video streams.

10. The system of claim 6, wherein the presentation templates comprise 2D or 3D environments simulating a 3D space, containing the presentation data and one or more data inputs such as live camera feeds, slide decks, real time data, static graphics, online documents, photos, videos and collaborative virtual whiteboards.

11. The system of claim 10, wherein the visual information are placed within the environments at pre-determined locations and/or placed between the viewpoint and the environment.
